(19) United States
(12) Patent Application Publication
(10) Pub. No.: US 2009/0112347 A1
(43) Pub. Date: Apr. 30, 2009

(54) Article Marking System

(76) Inventor: Geoffrey Michael George, New South Wales (AU)

Correspondence Address: WELLS ST. JOHN P.S., 601 W. FIRST AVENUE, SUITE 1300, SPOKANE, WA, 99201, US

(21) Appl. No.: 12/084,512

(22) PCT Filed: Oct. 25, 2006
(86) PCT No.: PCT/AU2006/001594

§ 371 Date: Jul. 15, 2008

(30) Foreign Application Priority Data
Nov. 1, 2005 (AU) 2005906046

(51) Int. Cl. G05D 7/06; G06F 17/00; G06F 7/00

(52) U.S. Cl. 700/110; 700/283; 700/213; 901/19

(57) ABSTRACT

A method of marking an article includes, in a control system, selecting one of a number of containers. The method further includes each container having a fluid containing respective unique marking elements therein. The method further includes generating control signals in accordance with the selected container. The method further includes transferring the control signals to a manipulator, the manipulator being responsive to the control signals to apply at least part of the fluid to the article to thereby marking the article with at least one marking element.

### BACKGROUND OF THE INVENTION

The present invention relates to a method and apparatus for marking an article, and in particular with a method and apparatus for marking an article such as a vehicle with marking elements such as DNA fragments.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

In many applications of product control and tracking, it is desirable to mark an article to allow its subsequent identification. This can be used for example if the article is stolen, to ensure the article is correctly identified and returned to its owner.

Whilst a number of visible marking schemes, such as barcodes are known, these are unsuitable in many instances for a number of reasons. Firstly, the barcodes are visible, and can therefore detract from the visual appeal of the article. Secondly, as barcodes can be simply imprinted or engraved, they are relatively easily to create and can therefore be easily modified and/or replaced.

In the case of vehicles, the problem is further exacerbated as vehicles can be broken down and rebuilt using parts from different vehicles. As a result, there is a need to ensure large numbers of vehicle parts are labelled.

One solution to this problem proposed in WO2002/40355 is to use whole of vehicle marking by handspraying data dots onto a vehicle. The datadots carrying the full 17 character vehicle identification number (VIN), encoded using a DNA trace. The manufacturer applies the datadots by manually spraying the dots onto the vehicle as part of an adhesive fluid mixture. However, this is a time consuming process and as it requires manual operation, is consequently relatively expensive.

### SUMMARY OF THE PRESENT INVENTION

In a first broad form the present invention provides a method of marking an article, the method including, in a control system:
a) selecting one of a number of containers, each container having a fluid containing respective unique marking elements therein;
b) generating control signals in accordance with the selected container; and,
c) transferring the control signals to a manipulator, the manipulator being responsive to the control signals to apply at least part of the fluid to the article to thereby marking the article with at least one marking element.

Typically the method includes, in the control system:
a) receiving indicating data from a sensing system, the indicating data being determined by sensing an identifier provided on at least one of the number of containers and being at least partially indicative of:
   i) the marking elements; and,
   ii) a container position;
b) generating the control signals in accordance with at least the container position.

Typically the container position is indicative of a position of the container on a transport system, and wherein the method includes, in the control system, and for each of the number of containers:
a) storing an indication of the container position; and,
b) updating the stored container position in accordance with the operation of the transport system.

Typically the method includes, in the control system, controlling the transport system to transport the number of containers to an accumulation area.

Typically the method includes, in the control system:
a) determining an identity of the article to be marked; and,
b) selecting the container in accordance with the determined article identity.

Typically the marking elements encode an identity, and wherein the method includes, in the control system, selecting the container such that the marking elements applied to an article encode the article identity.

Typically the article is provided on an assembly line, and wherein the method includes, in the control system:
a) determining an article identity of the next article on the assembly line;
b) determining if one of the number of containers contains marking elements encoding the article identity; and,
   i) in response to a successful determination, applying at least one marking element to the article from the determined container; and,
   ii) in response to an unsuccessful determination, causing at least one of:
      (1) an operator to manually provide a container having marking elements encoding the article identity; and,
      (2) removing the article from the assembly line.

Typically the method includes, in the control system, generating the control signals so as to cause the manipulator to:
a) engage a nozzle provided at a nozzle collection point;
b) couple the nozzle to the container;
c) apply at least some of the fluid to the article; and,
d) dispose of the nozzle and container.

Typically the manipulator includes a sensor for sensing an identifier provided on the container, and wherein the method includes, in the control system:
a) causing the sensor to sense the identifier provided on the container;
b) comparing the sensed identifier to an identity of the article to be marked; and,
c) causing fluid to be applied the article in response to a successful comparison.

In a second broad form the present invention provides apparatus for marking an article, the apparatus including a control system for:
a) selecting one of a number of containers, each container having a fluid containing respective unique marking elements therein;
b) generating control signals in accordance with the selected container; and,
c) transferring the control signals to a manipulator, the manipulator being responsive to the control signals to apply at least part of the fluid to the article to thereby marking the article with at least one marking element.

Typically the apparatus includes the manipulator.

Typically the manipulator includes a manipulator arm.

Typically the manipulator includes:
a) a body coupled to the arm; and,
b) a engaging mechanism for selectively engaging a spraying device for spraying at least part of the fluid from the container onto the article.

Typically the spraying device includes:
a) the container; and,
b) a nozzle coupled to the container.

Typically the nozzle includes:
a) a chamber having an inlet and an outlet;
b) a recess for receiving the container; and,
c) a pipe for extending into the container, the pipe being connected to the chamber such that the urging of a driving fluid from the inlet to the outlet causes fluid from the container to be ejected through the outlet.

Typically the container includes a film for sealing the container and wherein the pipe is for piercing the film when the container is coupled to the recess.

Typically the nozzle includes an annular recess, and wherein the engaging mechanism engages the annular recess.

Typically the apparatus includes a nozzle delivery mechanism, for providing the nozzles to a nozzle collection point.

Typically the manipulator includes a sensor for sensing an identifier provided on the container, the control system being responsive to signals from the sensing device to:
a) determine the identifier provided on the container;
b) compare the identifier to an identity of the article to be marked; and,
c) cause fluid to be applied the article in response to a successful comparison.

Typically the apparatus includes a sensing system for:
a) sensing an identifier provided on a container;
b) generating indicating data, the indicating data being at least partially indicative of:
   i) the marking elements; and,
   ii) a container position; and,
c) providing the indicating data to the control system, the control system generating the control signals in accordance with at least the container position.

Typically the apparatus includes a transport system for providing the containers to an accumulation area, the control system being for, for each of the number of containers:
a) storing an indication of the container position; and,
b) updating the stored container position in accordance with the operation of the transport system.

Typically the article is provided on an assembly line, the control system includes at least one indicator and wherein the control system is for:
a) determining an article identity of the next article on the assembly line;
b) determining if one of the number of containers contains marking elements encoding the article identity; and,
   i) in response to a successful determination, applying at least one marking element to the article from the determined container; and,
   ii) in response to an unsuccessful determination, causing at least one of:
      (1) generating an indication using the indicator to thereby cause an operator to manually provide a container having marking elements encoding the article identity; and,
      (2) removal of the article from the assembly line.

Typically the control system includes one or more suitably programmed processing systems.

Typically the control system is for performing the method of the first broad form of the invention.

In a third broad form the present invention provides apparatus for marking an article, the apparatus including a manipulator including:
a) a body for coupling to a manipulator arm;
b) a engaging mechanism for selectively engaging a spraying device, the spraying device including one of a number of containers, each container having a fluid containing respective unique marking elements therein; and,
c) an actuator for actuating the spraying device to thereby apply at least part of the fluid to the article to thereby marking the article with at least one marking element.
d) for spraying at least part of the fluid from the container onto the article.

Typically the spraying device includes a nozzle coupled to the container.

Typically the nozzle includes:
a) a chamber having an inlet and an outlet;
b) a recess for receiving the container; and,
c) a pipe connected to the chamber for extending into the container, and wherein actuator includes:
   i) a driving fluid outlet;
   ii) a driving fluid inlet for coupling to an driving fluid supply; and,
   iii) a flow path coupling the driving fluid outlet to the driving fluid inlet.
   iv) a solenoid for causing the driving fluid outlet to selectively engage the inlet such that the urging of a driving fluid through the nozzle inlet to the outlet causes fluid from the container to be ejected through the outlet.

Typically the nozzle includes an annular recess, and wherein the engaging mechanism engages the annular recess.

Typically the apparatus is used with apparatus according to the second broad form of the invention.

In a fourth broad form the present invention provides a method of marking an article, the method including:
a) selecting one of a number of containers, each container having a fluid containing respective unique marking elements therein;
b) controlling a manipulator to thereby cause the manipulator to:
   i) attaching a nozzle to the selected container; and,
   ii) dispense at least part of the fluid to thereby marking the article with at least one marking element.

Typically the method includes:
a) determining an identity of the article to be marked; and,
b) selecting the container in accordance with the determined identity.

Typically the method includes:
a) monitoring a position of the containers; and,
b) controlling the manipulator to attach the nozzle in accordance with the position of the selected container.

Typically the method includes, sensing an identifier provided on the containers to determine at least one of the position and an identity of marking elements.

Typically the method is performed using a control system operating using the method of the first broad form of the invention.

Typically the method is performed using the apparatus of the second broad form of the invention.

### BRIEF DESCRIPTION OF THE DRAWINGS

An example of the present invention will now be described with reference to the accompanying drawings, in which: —

FIG. 1 is a schematic diagram of an example of apparatus for marking a vehicle;

FIG. 2 is a schematic diagram of an example of the processing system of FIG. 1;

FIG. 3 is a flowchart of an example of a process for marking a vehicle using the apparatus of FIG. 1;

FIGS. 4A to 4C are schematic diagrams of an example of a nozzle;

FIGS. 5A and 5B are schematic diagrams of an example of a pod for use with the nozzle of FIGS. 4A to 4C;

FIGS. 6A to 6C are schematic diagrams of an example of a mounting system for mounting the nozzle of FIGS. 4A to 4C to a manipulator arm;

FIGS. 7A and 7B are schematic plan and side views of an example of a tray for carrying the pods of FIGS. 5A and 5B;

FIGS. 8A to 8C are a flowchart of an example of a process for marking a vehicle using the apparatus of FIG. 1; and,

FIGS. 9A and 9B are schematic plan and side views of a second example of apparatus for marking a vehicle.

### DETAILED DESCRIPTION OF THE PREFERRED EMBODIMENTS

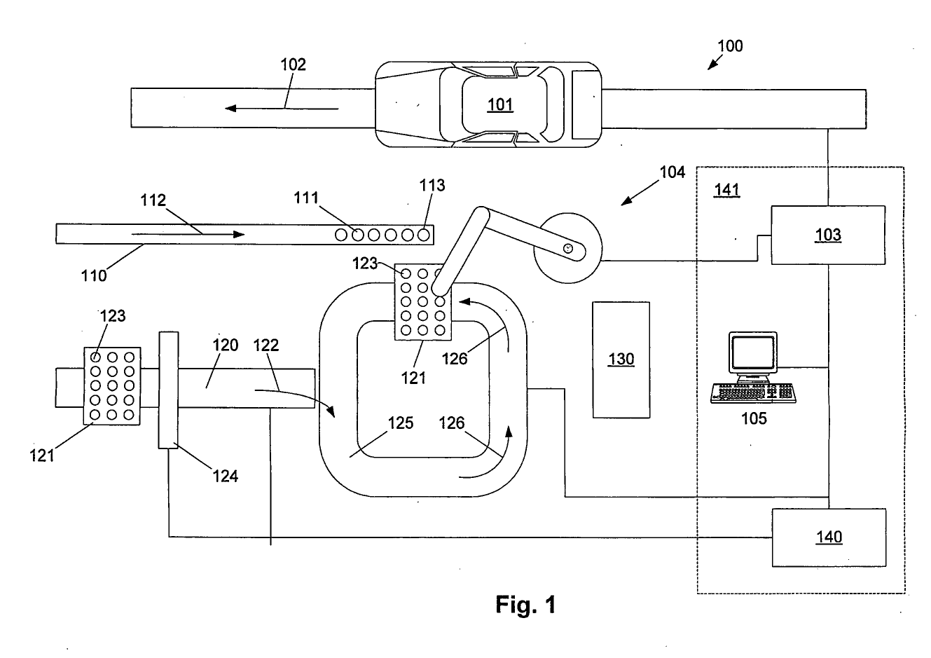

An example of apparatus for marking an article, in the form of a vehicle, will now be described with reference to FIG. 1.

In this example, the apparatus includes an assembly line 100 for transporting vehicles, in this example a car 101, in a transport direction 102. Operation of the assembly line 100 is controlled via a sequence controller 103 which is also coupled to a manipulator arm 104, such as a Kuka KR30L16 robot arm, and a processing system 105.

The apparatus includes a nozzle delivery chute 110 for delivering nozzles 111 in a nozzle delivery direction 112 to a nozzle collection point 113. A pod delivery transport 120, such as a conveyor belt, is provided for transporting a pod tray 121 in a delivery direction 122. The pod tray includes a number of pods 123 arranged in an array as shown. A sensing system 124 is mounted adjacent the pod delivery transport for sensing pods 123 passing therethrough. The pod delivery transport 120 is connected to a pod accumulation transport 125 positioned adjacent the manipulator arm 104 as shown.

A controller 140 is coupled to the sequence controller 103, the processing system 105, the sensing system 140 and the pod delivery and accumulation transports 120, 125 as shown.

In use, the sequence controller 103, the controller 140 and the processing system 105 form a control system 141 for controlling the apparatus. It will be appreciated that any form of control system may be used, and that the example herein is for the purpose of illustration only.

In this example, the sequence controller 103 operates to generate commands to control the assembly line 100 and the manipulator arm 104. The commands are typically stored and represent a sequence of movements required to implement the desired functionality. Operation of such sequence controllers is known in the art and will not therefore be described in any further detail.

In this example, the controller 140 controls operation of the pod and accumulation transports 120, 125, thereby allowing pod trays 121 to be moved from a loading position to an accumulation area adjacent the manipulator arm 104. The controller 140 uses signals from the determines the position and identity of the pods 123 and generates commands which are transferred to the sequence controller 103 to thereby cause the sequence controller to control the assembly line 100 and the manipulator arm 104 as required. Accordingly, the controller 140 may be any form of suitable controller but in one example is a PLC (Programmable Logic Controller), such as an Allen Bradley CompactLogix PLC.

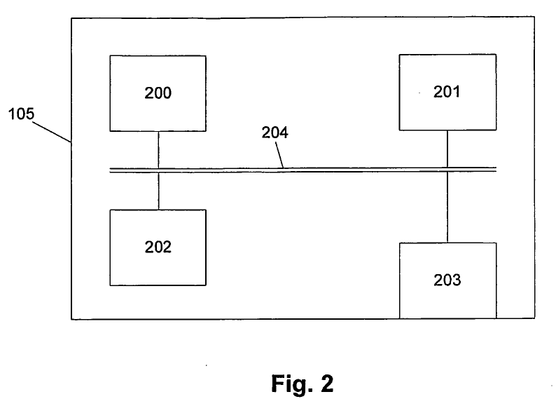

The processing system 105 is used to allow user interface with the sequence controller 103 and the controller 140. An example of the processing system 105 is shown in FIG. 2. In particular, as shown the processing system 105 is formed from a processor 200, a memory 201, an input/output device 202, such as a keyboard and display or the like and an external interface 203 coupled together via a bus 204. The processing system 105 is connected to the sequence controller 103 and the controller 140 using the external interface 203, and it will be appreciated that this may be via a wired or wireless connection, and optionally via a network.

It will therefore be appreciated that the processing system 105 may be any form of suitable processing system such as a desktop computer, lap-top computer or the like. In one specific embodiment, the processing system 2 operates to execute applications software to thereby implement an appropriate user interface, such as a PanelView Plus 700 user interface.

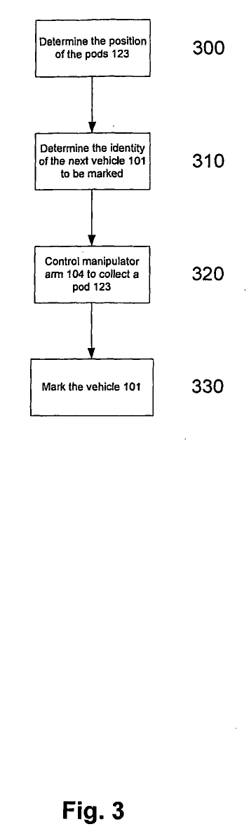

An example of a marking process performed will now be outlined with respect to FIG. 3.

At step 300, position of pods 123 in the pod trays 121 is determined. This can be achieved in any suitable manner, such as by using the sensing system 124 to detect an initial pod position. The pods 123 can then be transferred to the accumulation transport 125, and transported in the direction of the arrows 126 to allow pod collection in an accumulation area (not shown) near the manipulator arm, with motion of the pods 123 being used to determine their current position. Alternatively, however, the position of the pods 123 may be determined by a suitable sensing means once the pods 123 reach the accumulation area.

At step 310 the VIN of the next vehicle of the next 101 to be marked is determined. This information is then used by the controller 140 and the sequence controller 103 to activate the manipulator arm 104 and collect a pod 123 from the accumulation area, at step 320. At step 330 the pod is used to apply an identifying mark to the vehicle at one or more locations.

In use, each pod 123 contains a unique marking element, such an identifier particle suspended in a suitable base fluid. By associating the marking element with the vehicle VIN, this allows the marking element to uniquely identify the vehicle.

In one example the marking element is formed from DNA identifiers, or synthetic DNA labels, allowing the DNA to actually encode the VIN, resulting in each pod 123 being intended for use on a specific vehicle 101. In this instance each pod 123 can be uniquely marked using an identifier such as a barcode, to allow pods to be identified using the sensing system 124, as will be described in more detail below.

Any suitable form of base fluid may be used as long as this is sufficiently inert that it does not react with, or other wise affect the marking elements, and as long as it provides sufficient adhesive properties to ensure the marking elements adhere to the vehicle surface. Examples of base fluids, without limitation, are adhesives, paints, polymers, foam, undercoatings for application to vehicles, to name just a few.

Alternatively, however, any unique identity may be represented by the marking elements, which may include micro-labels, biological elements, rare earth minerals utilised for tracing (such as those minerals and services offered by Austguard of Perth Australia), UV detectable particles or substances, micro dots, data dots, unique or identifiable chemical compounds and others. In this case, an association between the VIN and the identity of the marking element may be recorded at any stage, such as after a pod 123 has been selected by the manipulator arm 104, or even after the vehicle has been marked.

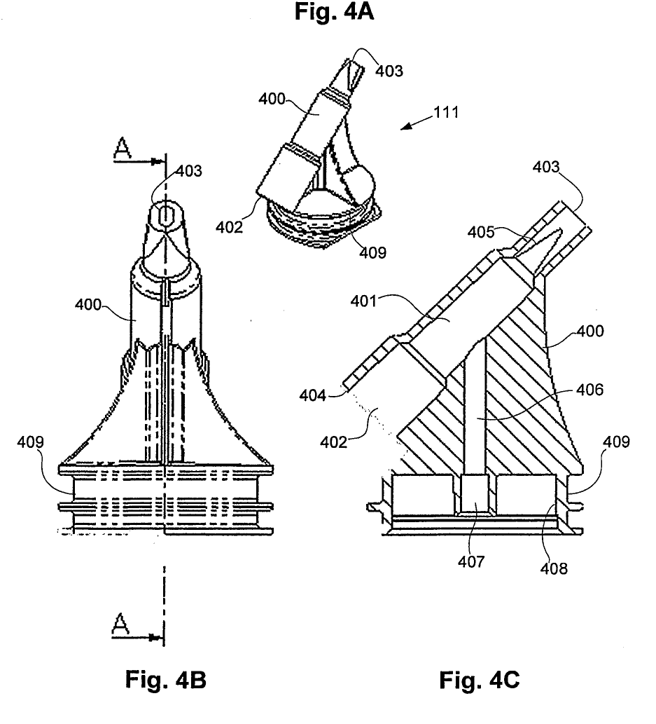

In one example the pods 123 are coupled to a nozzle 111, to form a single use spraying device to be used for marking a respective vehicle 101. This prevents contamination of the marks on one vehicle with marking elements used on a different vehicle. One example of the nozzles 101 used in this process will now be described in more detail with respect to FIGS. 4A to 4C.

The nozzle 111 is formed from a body 400 typically formed from a material such as polyurethane or the like. The body 400 defines a chamber 401 having an inlet 402 and an outlet 403. The inlet 402 includes a valve seat 404 which is adapted to engage a seal to allow a driving fluid, such as compressed air, an aerosol or air/aerosol combination, to be supplied via the inlet 402, as will be described in more detail below. A discharge nozzle 405 is provided adjacent the outlet 403, as shown.

A connection pipe 406 extends from the chamber to a connector 407, which in use is connected to a pipe 410, having a pointed end 411. The housing 400 includes a recess 408 for connecting to a pod 123. An annular recess shown generally at 409 is provided to allow the nozzle to be attached to the manipulator arm 104 as will be described in more detail below.

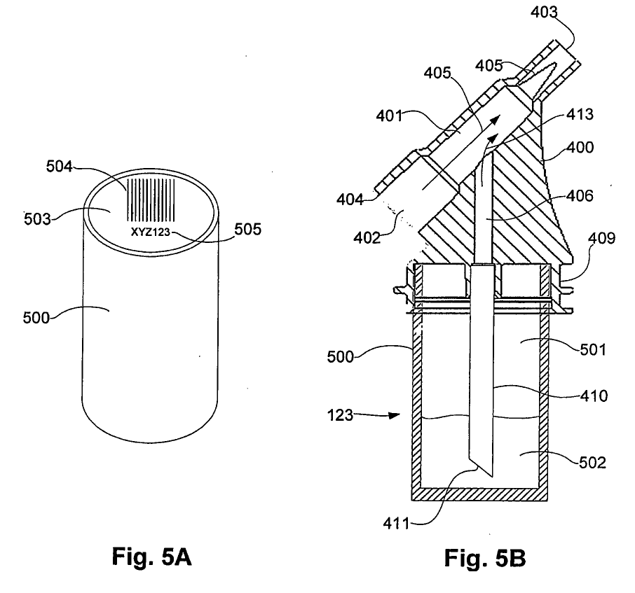

An example of a pod 123 is shown in more detail in FIG. 5A with the pod 123 fitted to a nozzle 111 being shown in FIG. 5B.

The pod includes a body 500 defining a cavity 501 containing the fluid 502 including the marking elements. In one example, this includes 7000 marking elements and 70 ml of adhesive fluid, although any suitable arrangement may be used. The pod 123 is sealed by a film 503, such as a foil seal, which is marked with a barcode 504 and optionally with alphanumeric characters 505, both of which identify the fluid contained therein. In the event that the marking elements encode the VIN, then the VIN may be used.

In use, the nozzle 111 is coupled to the pod 123 by using the pointed end 411 of the pipe 410 to pierce the film 503. The pipe is inserted into the cavity 501 such that the pointed end 411 is immersed in the fluid 502, with the pod body 500 cooperating with the recess 408 to sealing engage the pod body 500 and the nozzle body 400, as shown in FIG. 5B.

In use, compressed air supplied via the inlet 402 flows through the chamber 401, as shown by the arrow 412, and is forced through the discharge nozzle 405 and expelled from the outlet 403. This generates a reduced pressure in the pipe 410 and the connecting pipe 406, causing fluid 502 to flow into the chamber 401, as shown by the arrow 413. The fluid becomes entrained in the air flowing through the chamber 401, and as a result is expelled from the outlet as a jet. The diffuser 405 operates to atomise the fluid 502 so that the marking elements are dispersed in fluid droplets, allowing them to be sprayed onto a vehicle surface.

It will be appreciated from this that the pod can be any form of container and that the term pod is used for the purpose of example only.

In order to allow manipulation of the nozzle 111 a mounting system is provided on the end of the manipulator arm 104. An example of this will now be described with reference to Figure to 6A to 6C.

The mounting system includes a body 600 having a fitting member 601 allowing the body 600 to be attached to the manipulator arm 104. The mounting system includes first and second jaws 602A, 602B which are coupled to a jaw actuator (not shown) via mounting blocks 603A, 603B, thereby allowing the jaws to be opened and closed, as shown by the arrow 613.

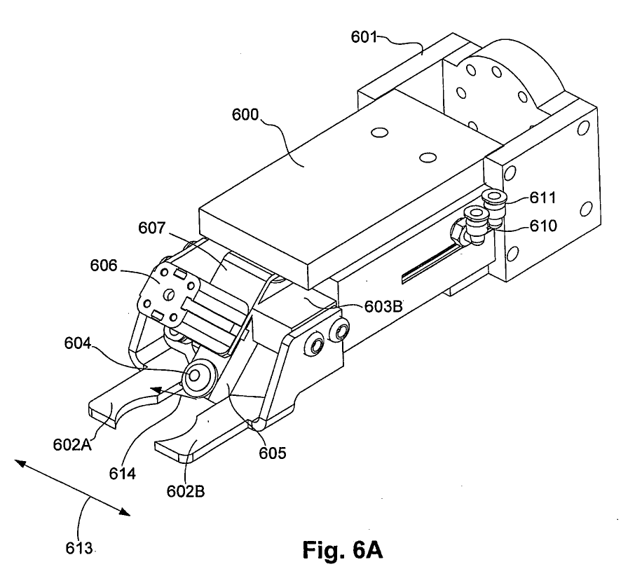

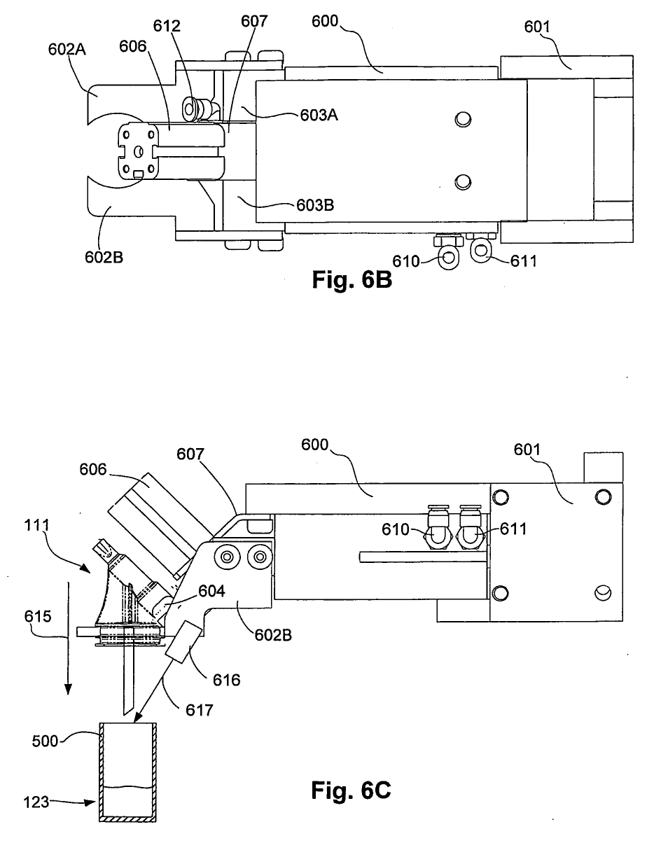

An air supply outlet 604 is provided on an arm 605 coupled to an actuator 606, which is in turn coupled to the body 600 by a support 607. The actuator 606 is adapted to allow the support 605 to be moved in the direction of the arrow 614, thereby allowing the air outlet 604 to selectively seal against the inlet seat 404 provided on the nozzle 111 as shown in FIG. 6C.

The arm mounting system also includes a number of air inlets and outlets 610, 611, 612 for receiving a supply of compressed air. This allows for actuation of the jaws 602, the actuator 606, as well as to supply air to the nozzle 111.

An optional sensor 616, such as a barcode scanner may be provided on the mounting system, to allow the barcode 504 to be sensed as shown at 617. In one example, this is a Cognex “5401” model Vision system, although any suitable sensor may be used.

In use, the jaws 602 can be aligned with the annular recess 409 and then closed to allow the jaws 602 to grasp the nozzle 111. The nozzle 111 can then be aligned with a respective one of the pods 123, as shown in FIG. 6C. This allows the barcode 504 to be sensed, before the nozzle is moved in the direction of the arrow 615, causing the film 503 to be pierced and allowing the pod 123 to be attached to the nozzle 111.

During this process the actuator 606 can be used to seal the air supply outlet 604 engage the inlet 402, allowing compressed air to be supplied to the chamber 401, to thereby dispense fluid 502 from the pod 123 as described above.

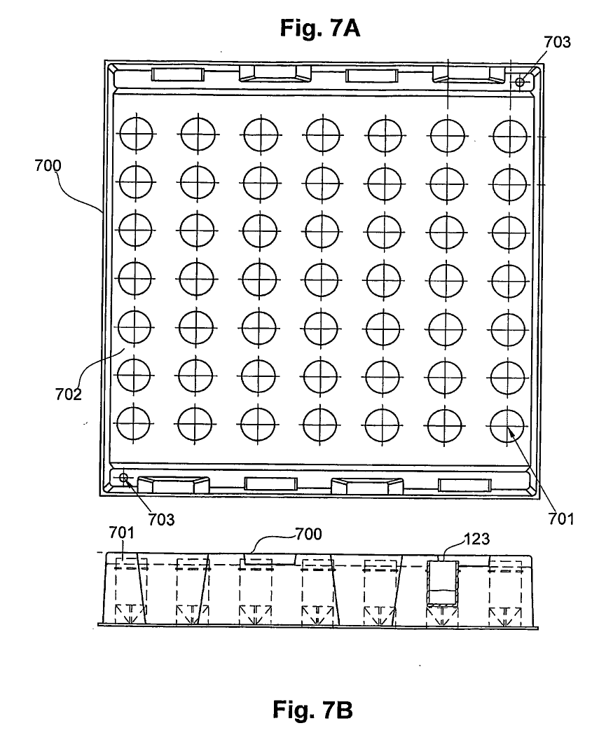

An example of the pod tray 121 used for transporting the pods 123 to the accumulation area is shown in more detail in FIGS. 7A and 7B.

As shown the tray is formed from a body 700 having a number of recesses 701 formed in a polycarbonate base 702. The recesses are adapted to accommodate the pods 123 as shown in FIG. 7B. The body also includes locator pins 703, which cooperate with guides provided on the transport systems 120, 125 to ensure accurate alignment of the tray 121.

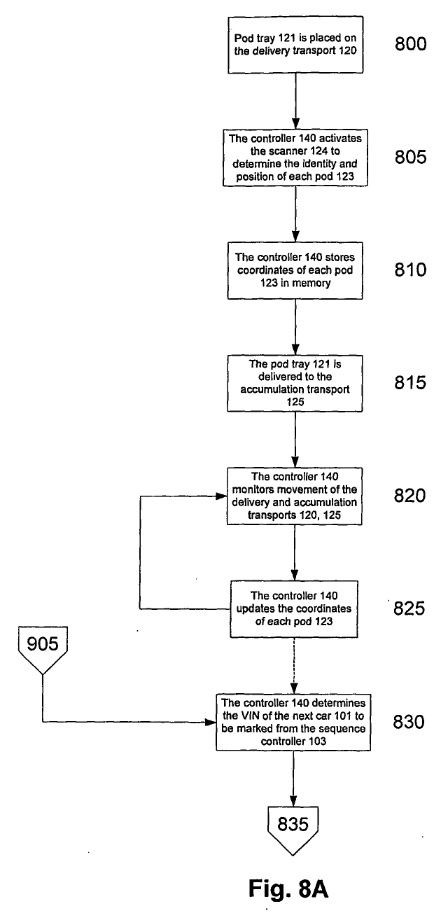

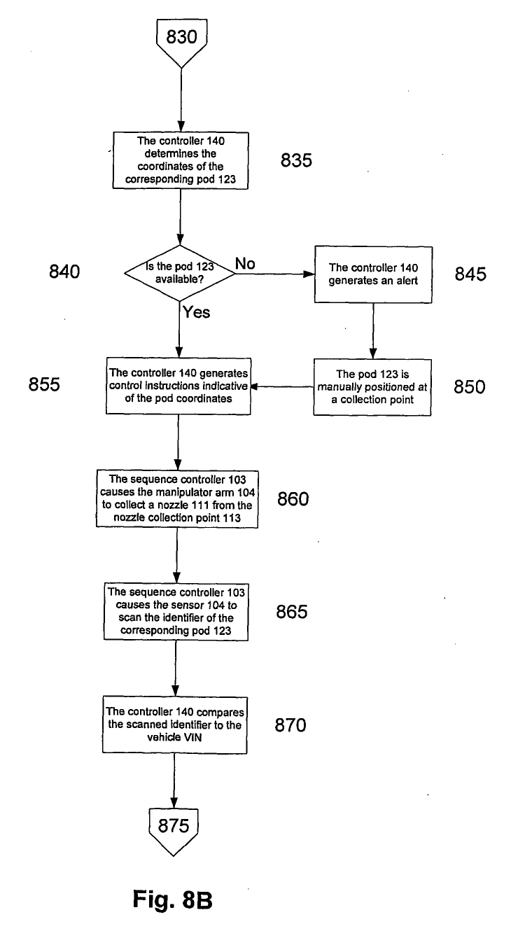

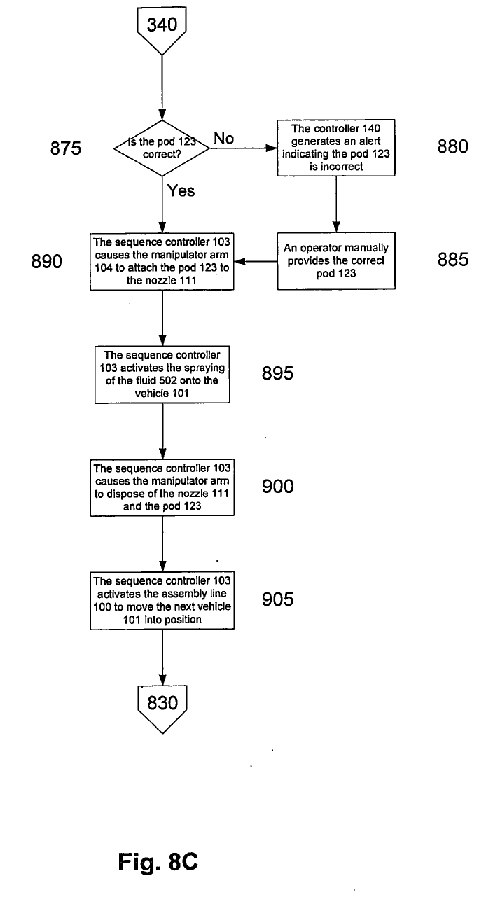

A specific example of the operation of the apparatus of FIG. 1 to mark a vehicle will now be described in more detail with respect to FIG. 8A to 8C.

At step 800, a pod tray 121 is placed on the delivery transport 120. At step 805 the controller 140 the sensing system 124 detects the barcode 504 and uses this to determine the VIN associated with the pod 123 as well as the position of each pod 123. The position of each pod 123 is stored as pod coordinates in a memory at step 810. It will be appreciated that any form of sensing system 124 may be used but in one example this is in the form of a laser barcode sensing system and in another example this is achieved utilising a video imaging system which images the film 503 and utilises image analysis software to interpret the barcodes 504. In one example, the sensing system 124 is a Cognex “5401” model Vision system, although any suitable sensor system may be used.

At step 815 the pod tray 121 is moved to the accumulation transport 125. During this process, at step 820 the controller 140 monitors movement of the delivery and accumulation transports 120, 125 and uses this information to update the pod coordinates of each pod 123 at step 825. To ensure accurate updating of the pod coordinates the delivery and accumulation transports 120, 125 are arranged to move the pod trays 121 with a high degree of positional certainty. Accordingly once the transports 120, 125 may be formed from standard conveyor belts, this usually does not provide the required degree of certainty in position and accordingly, the transport is more typically an arrangement that grips the pod trays 121 to ensure more accurate positioning.

An example of a suitable system is a flexlink XT pallet conveyor component. This can include for example an XT loop conveyor to form the accumulation transport 125, and an XT straight conveyor to form the pod delivery transport 120. In this example, each conveyor can be fitted with a fixed speed SEW reversible gearmotor to control conveyor movement, with sensors and brackets being used to ensure accurate pallet location.

At step 830 the controller 140 determines the VIN of the next car 101 to be marked from the sequence controller 103, and then determines the pod coordinates of the corresponding pod 123 at step 835. This allows correct matching of the pod 123 to the corresponding vehicle 101. If it is determined that the pod 123 is not provided in the accumulation area, and hence is unavailable at step 840 the processor moves to 845 with the controller 140 generating an alert. This may be displayed to an operator for example via the processing system 105 indicating to the operator that the pod 123 must be manually positioned at a collection point at step 850. This may be achieved for example by providing the required pod 123 at a manual collection point not shown. If this cannot be achieved, it may be necessary to remove the vehicle 101 from the assembly line 100, thereby allowing the next vehicle 101 to be marked.

In general, this process may be performed so as to analyse the next few, such as the next five vehicles 101 on the assembly line. This allows warnings to be generated a sufficient time in advance of a vehicle being marked, thereby allowing necessary manual intervention to be performed without having to stop the assembly line and thereby interrupt the manufacturing process.

Once the pod 123 is determined to be available, the controller 140 generates control instructions indicative of the pod coordinates and transfers these to the sequence controller is 103, at step 855. The sequence controller 103 causes the manipulator arm to collect a nozzle from the nozzle collection point 113 at step 860, activating the jaws 602 to grip the nozzle 111 as described above. At step 865 the sequence controller 103 activates the manipulator arm 104 to thereby move the manipulator arm to the indicated pod coordinates. At this point, the sensor 616 may be used to scan the barcode 504 to thereby confirm that the correct pod 123 is being mounted to the nozzle 111. To achieve this, an indication of the scanned barcode is provided by the sensor 616, via the sequence controller 103, to the controller 140 which compares the sensing system identifier to the indicated vehicle VIN at step 870.

At step 875 if it is determined that the scanned pod 123 is not correct the controller 140 generates an alert indicating that the pod 123 is incorrect at step 880. Again this may be achieved by displaying an alert on the processing system 105 allowing an operator to manually provide the correct pod 123 at an appropriate pod collection position at step 885, in a manner similar to that described above.

In any event once it is confirmed that the correct pod is available the sequence controller 103 causes the manipulator arm 104 to attach the pod 123 to the nozzle 111 at step 890. At this point the manipulator arm 104 can be moved so as to agitate the fluid 502, for example by shaking the pod 123, thereby ensuring even distribution of the marker elements throughout the fluid 502.

The sequence controller 103 activates a compressed air supply causing the fluid 502 to be sprayed onto the vehicle 101 at step 895. The vehicle 101 may be sprayed at one or more locations by appropriate movement of the manipulator arm 104, with the operation being controlled by a suitable sequence of commands pre-stored in the sequence controller 103, as will be appreciated by persons skilled in the art.

Examples of vehicle locations that may be marked include:
Floor Pan, 4 locations on vertical surfaces to limit the effect of abrasion from road grime. This includes the sides of the chassis rails and the differential housing well;
Drivetrain, including engine, bell housing, transmission and differential;
Upper and lower arms of the suspension;
Brake assembly and callipers;
Front mudguard panels;
Side assembly & rear quarter panel;
Underneath door frames near water drain holes;
Hood inside reinforcing channels;
Front & Rear bumpers;
Compliance plate; and,
Pickup box and/or cargo boxes in utilities.

At step 900 the sequence controller causes the manipulator arm 104 to dispose of the nozzle 111 and the pod 123 in the disposal points 130. The sequence controller 103 then activates the assembly line 100 to move the next vehicle 101 into position at step 905. The process then returns to step 830 with the controller determining the VIN of the next car 101 to be marked from the sequence controller 103.

Thus, it will be appreciated by persons skilled in the art that during this process pod trays 121 are constantly fed onto the transport and moved around the accumulation transport 125 to allow the manipulator arm 104 to collect a pod 123 containing marking materials indicative of the VIN of the vehicle 101 to be marked.

As mentioned above, an operator can interact with and control the operation of the process using the processing system 105. The types of functionality provided include:
setting system parameters;
viewing locations of all pods in the system, by tray number and location on the tray;
viewing spray cycle times for different vehicle models; and,
requesting empty trays (or near empty if a pod was not used due to a vehicle body being removed from production) to be transferred to the loading station.

The examples set out above focus on the marking of an article in an assembly line environment. However, it will be appreciated that the process may also be utilised in other environments, for example to mark articles post production.

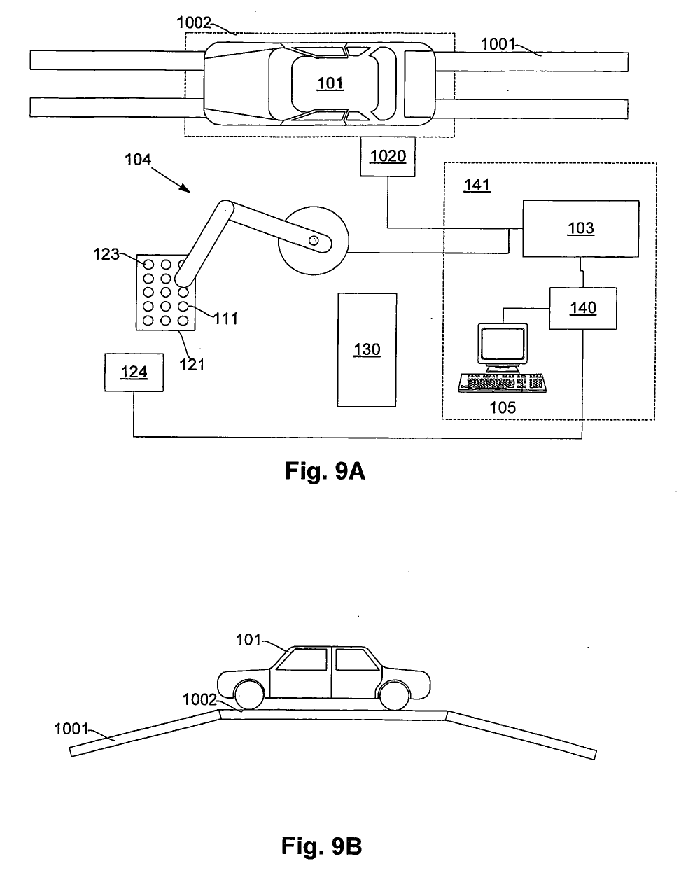

This can be achieved using apparatus similar to that shown in FIG. 1, with the assembly line 100 being replaced by an alternative mechanism for allowing the vehicles to be marked. An example of this will now be described with reference to FIGS. 9A and 9B.

In this example, the assembly line 100 is replaced by two ramps 1001 which provide access to a raised platform 1002. In use the vehicle 101 is driven up the ramps 1001 and positioned on the platform 1002 in accordance with markings provided thereon. Use of the platform has two main benefits. Firstly, the raised platform 1002 provides access to the underside of the vehicle as shown in FIG. 9B, allowing the manipulator arm 104 to be utilised to mark both the underside and topside of the car 101. Secondly, the use of the platform constrains the positioning of the car 101, thereby helping to ensure that the car 101 is marked in the correct positions.

To further ensure correct marking, and to avoid relying solely on alignment of the car 101 with markings on the platform 1002, a suitable position sensor may be used as shown generally at 1020. In this example, the position sensor 1020 detects the position of the car on the platform 1002 and provides an indication of this to the sequence controller 103. This allows the sequence controller 103 to control the manipulator arm 104 in accordance with the position of the car 101, thereby ensuring accurate marking.

It will be appreciated by persons skilled in the art, that the position sensor 1020 may be any form of sensor system, such as a pressure sensor adapted to sense the position of car wheels on the platform 1002, or an optical sensor adapted to sense the position of the car body, or the like.

In one example, the remainder of the apparatus is substantially the same as shown in FIG. 1. This allows markings to be provided at appropriate multiple locations on the vehicle in a manner similar to that previously described, albeit without requiring appropriate control of the assembly line. Thus, in this example, the apparatus would be substantially as described in FIG. 1, with the platform 1002 replacing the assembly line 100.

However, further variations are also possible. Thus, as shown in FIG. 9A, it is possible for the system to utilise a pod and nozzle delivery system of reduced complexity. In this example, the apparatus does not include either a nozzle delivery chute 110 or a pod delivery transport 120, but rather delivers the nozzles 111 and corresponding pods 120 using a common pod tray 121. In this example, the pod tray 121 can be manually provided to a delivery position, allowing the manipulator arm 104 to retrieve a nozzle 111, mount this to a pod 120, and then apply the pod content to the car 101.

In this example, the exact positioning and identity of the pods may still need to be confirmed, to ensure that the vehicle is correctly marked. This may be achieved using any suitable sensing system, such as a image capture device, positional sensor, or the like. It will therefore be appreciated that this may use sensors similar to the sensing system 124 and/or the optional sensor 616, provided on the manipulator arm 104.

The arrangement of FIG. 9A avoids the need to control the pod delivery transport 120, which in turn simplifies the control processes. However, this does require that the pod tray 121 is manually provided to a pod delivery position, thereby increasing the manual intervention required. However, as manual positioning of the car 101 on the platform 1002 is required, the additional manual positioning of the pod tray 121 does not represent an undue burden. However, as mentioned above, a pod delivery transport could be used, and this is for the purpose of example only.

Finally, it will be appreciated that features of the examples shown in FIG. 1 and FIG. 9A may be used interchangeably, so that, for example, manual provision of pod trays 121 could be used in the arrangement of FIG. 1.

The techniques of the invention may be applied to any vehicle such as an automobile, truck, car, boat, ship, train, or the like. Additionally, whilst the description focuses on the application of the marking elements to vehicles, these techniques may be used to mark any high value article. This may be performed either as part of a manufacturing process using an assembly line arrangement similar to that shown in FIG. 1. Alternatively this can be performed post production, using a suitable arrangement, such as that shown in FIG. 9A. It will be appreciated that different configurations and combinations of the above described examples may be used depending on the nature of the article and the circumstance in which the article is to be marked.

Persons skilled in the art will appreciate that numerous variations and modifications will become apparent. All such variations and modifications which become apparent to persons skilled in the art, should be considered to fall within the spirit and scope that the invention broadly appearing before described.

1) A method of marking an article, the method including, in a control system:
a) selecting one of a number of containers, each container having a fluid containing respective unique marking elements therein;
b) generating control signals in accordance with the selected container; and,
c) transferring the control signals to a manipulator, the manipulator being responsive to the control signals to apply at least part of the fluid to the article to thereby marking the article with at least one marking element.

2) A method according to claim 1, wherein the method includes, in the control system:
a) receiving indicating data from a sensing system, the indicating data being determined by sensing an identifier provided on at least one of the number of containers and being at least partially indicative of:
i) the marking elements; and,
ii) a container position;
b) generating the control signals in accordance with at least the container position.

3) A method according to claim 2, wherein the container position is indicative of a position of the container on a transport system, and wherein the method includes, in the control system, and for each of the number of containers:
a) storing an indication of the container position; and,
b) updating the stored container position in accordance with the operation of the transport system.

4) A method according to claim 3, wherein the method includes, in the control system, controlling the transport system to transport the number of containers to an accumulation area.

5) A method according to claim 1, wherein the method includes, in the control system:
a) determining an identity of the article to be marked; and,
b) selecting the container in accordance with the determined article identity.

6) A method according to claim 5, wherein the marking elements encode an identity, and wherein the method includes, in the control system, selecting the container such that the marking elements applied to an article encode the article identity.

7) A method according to claim 1, wherein the article is provided on an assembly line, and wherein the method includes, in the control system:
a) determining an article identity of the next article on the assembly line;
b) determining if one of the number of containers contains marking elements encoding the article identity; and,
i) in response to a successful determination, applying at least one marking element to the article from the determined container; and,
ii) in response to an unsuccessful determination, causing at least one of:
(1) an operator to manually provide a container having marking elements encoding the article identity; and,
(2) removing the article from the assembly line.

8) A method according to claim 1, wherein the method includes, in the control system, generating the control signals so as to cause the manipulator to:
a) engage a nozzle provided at a nozzle collection point;
b) couple the nozzle to the container;
c) apply at least some of the fluid to the article; and, d) dispose of the nozzle and container.

9) A method according to claim 1, wherein the manipulator includes a sensor for sensing an identifier provided on the container, and wherein the method includes, in the control system:
a) causing the sensor to sense the identifier provided on the container;
b) comparing the sensed identifier to an identity of the article to be marked; and,
c) causing fluid to be applied the article in response to a successful comparison.

10) Apparatus for marking an article, the apparatus including a control system for:
a) selecting one of a number of containers, each container having a fluid containing respective unique marking elements therein;
b) generating control signals in accordance with the selected container; and,
c) transferring the control signals to a manipulator, the manipulator being responsive to the control signals to apply at least part of the fluid to the article to thereby marking the article with at least one marking element.

11) Apparatus according to claim 10, wherein the apparatus includes the manipulator.

12) Apparatus according to claim 11, wherein the manipulator includes a manipulator arm.

13) Apparatus according to claim 12, wherein the manipulator includes:
a) a body coupled to the arm; and,
b) a engaging mechanism for selectively engaging a spraying device for spraying at least part of the fluid from the container onto the article.

14) Apparatus according to claim 13, wherein the spraying device includes:
a) the container; and,
b) a nozzle coupled to the container.

15) Apparatus according to claim 14, wherein the nozzle includes:
a) a chamber having an inlet and an outlet;
b) a recess for receiving the container; and,
c) a pipe for extending into the container, the pipe being connected to the chamber such that the urging of a driving fluid from the inlet to the outlet causes fluid from the container to be ejected through the outlet.

16) Apparatus according to claim 15, wherein the container includes a film for sealing the container and wherein the pipe is for piercing the film when the container is coupled to the recess.

17) Apparatus according to claim 15, wherein the nozzle includes an annular recess, and wherein the engaging mechanism engages the annular recess.

18) Apparatus according to claim 14, wherein the apparatus includes a nozzle delivery mechanism, for providing the nozzles to a nozzle collection point.

19) Apparatus according to claim 11, wherein the manipulator includes a sensor for sensing an identifier provided on the container, the control system being responsive to signals from the sensing device to:
a) determine the identifier provided on the container;
b) compare the identifier to an identity of the article to be marked; and,
c) cause fluid to be applied the article in response to a successful comparison.

20) Apparatus according to claim 10, wherein the apparatus includes a sensing system for:
a) sensing an identifier provided on a container;
b) generating indicating data, the indicating data being at least partially indicative of:
i) the marking elements; and,
ii) a container position; and,
c) providing the indicating data to the control system, the control system generating the control signals in accordance with at least the container position.

21) Apparatus according to claim 20, wherein the apparatus includes a transport system for providing the containers to an accumulation area, the control system being for, for each of the number of containers:
a) storing an indication of the container position; and,
b) updating the stored container position in accordance with the operation of the transport system.

22) Apparatus according to claim 10, wherein the article is provided on an assembly line, the control system includes at least one indicator and wherein the control system is for:
a) determining an article identity of the next article on the assembly line;
b) determining if one of the number of containers contains marking elements encoding the article identity; and,
i) in response to a successful determination, applying at least one marking element to the article from the determined container; and,
ii) in response to an unsuccessful determination, causing at least one of:
(1) generating an indication using the indicator to thereby cause an operator to manually provide a container having marking elements encoding the article identity; and,
(2) removal of the article from the assembly line.

23) Apparatus according to claim 10, wherein the control system includes one or more suitably programmed processing systems.

24. (canceled)

25) Apparatus for marking an article, the apparatus including a manipulator including:
a) a body for coupling to a manipulator arm;
b) a engaging mechanism for selectively engaging a spraying device, the spraying device including one of a number of containers, each container having a fluid containing respective unique marking elements therein; and,
c) an actuator for actuating the spraying device to thereby apply at least part of the fluid to the article to thereby marking the article with at least one marking element.
d) for spraying at least part of the fluid from the container onto the article.

26) Apparatus according to claim 25, wherein the spraying device includes a nozzle coupled to the container.

27) Apparatus according to claim 26, wherein the nozzle includes:
a) a chamber having an inlet and an outlet;
b) a recess for receiving the container; and,
c) a pipe connected to the chamber for extending into the container, and wherein actuator includes:
i) a driving fluid outlet;
ii) a driving fluid inlet for coupling to an driving fluid supply; and,
iii) a flow path coupling the driving fluid outlet to the driving fluid inlet.
iv) a solenoid for causing the driving fluid outlet to selectively engage the inlet such that the urging of a driving fluid through the nozzle inlet to the outlet causes fluid from the container to be ejected through the outlet.

28) Apparatus according to claim 27, wherein the nozzle includes an annular recess, and wherein the engaging mechanism engages the annular recess.

29. (canceled)

30) A method of marking an article, the method including:
a) selecting one of a number of containers, each container having a fluid containing respective unique marking elements therein;
b) controlling a manipulator to thereby cause the manipulator to:
i) attaching a nozzle to the selected container; and,
ii) dispense at least part of the fluid to thereby marking the article with at least one marking element.

31) A method according to claim 30, wherein the method includes:
a) determining an identity of the article to be marked; and,
b) selecting the container in accordance with the determined identity.

32) A method according to claim 31, wherein the method includes:
a) monitoring a position of the containers; and,
b) controlling the manipulator to attach the nozzle in accordance with the position of the selected container.

33) A method according to claim 32, wherein the method includes, sensing an identifier provided on the containers to determine at least one of the position and an identity of marking elements.

34-35. (canceled)
